(19) United States
(12) Patent Application Publication
(10) Pub. No.: US 2012/0294281 A1
(43) Pub. Date: Nov. 22, 2012

(54) DATA DELIVERY METHOD PERFORMED IN RECEIVING APPARATUS OF MOBILE COMMUNICATION SYSTEM

(75) Inventor: Hyun Seo PARK, Daejeon (KR)

(73) Assignee: Electronics and Telecommunications Research Institute, Daejeon (KR)

(21) Appl. No.: 13/472,050

(22) Filed: May 15, 2012

(30) Foreign Application Priority Data
May 16, 2011 (KR) 10-2011-0045838
Dec. 9, 2011 (KR) 10-2011-0131919

(51) Int. Cl. H04W 72/04; H04W 36/00; H04W 4/18

(52) U.S. Cl. 370/331; 370/328; 370/329

(57) ABSTRACT

Provided is a data delivery method performed in a receiving apparatus of a mobile communication system. Protocol data units (PDUs) are received, and service data units (SDUs) are extracted from the received PDUs and delivered to an upper layer in real time. Alternatively, it is determined whether a PDU gap, in which PDUs are not received in sequence, has occurred on the basis of sequence numbers (SNs) of received PDUs, a reordering timer (t_Reordering) is started when a PDU gap has occurred, and at least one SDU is extracted from at least one PDU, which have been received already, and delivered to an upper layer of radio link control (RLC) when the reordering timer expires and no PDU corresponding to the PDU gap is received.

### CLAIM FOR PRIORITY

This application claims priority to Korean Patent Application No. 10-2011-0045838 filed on May 16, 2011 and No. 10-2011-0131919 filed on Dec. 9, 2011 in the Korean Intellectual Property Office (KIPO), the entire contents of which are hereby incorporated by reference.

### BACKGROUND

1. Technical Field

Example embodiments of the present invention relate in general to a mobile communication system, and more particularly, to a data delivery method that can be applied to a Layer-2 protocol of mobile communication systems including Long Term Evolution (LTE), LTE-Advanced and Worldwide Interoperability for Microwave Access (WiMAX) systems.

2. Related Art

In an LTE, LTE-Advanced or WiMAX system, a data retransmission function is performed in Layer 2. Retransmission of data having an error is mainly performed using a hybrid automatic repeat request (HARQ) scheme of the medium access control (MAC) layer, and complemented by a retransmission function of the radio link control (RLC) protocol.

The RLC protocol performs an in-sequence delivery function of providing information on protocol data units (PDUs) that have not been successfully received to a transmitting side in a form referred to as a status report, receiving data retransmitted from the transmitting side, and delivering the received data to an upper layer in the same sequence as transmitted from the transmitting side. To perform a function as described above, RLC adds an RLC header to each PDU, and a sequence number (SN) for tracking the PDU that is being transmitted or received is included in the RLC header together with other fields.

Specifically, according to a Layer 2 protocol of terminals and base stations in mobile communication systems including LTE, LTE-Advanced and WiMAX systems, RLC in acknowledged mode (AM) starts a reordering timer when a PDU gap occurs due to a HARQ failure or HARQ feedback NACK-to-ACK error. When the reordering timer expires, the RLC in AM requests retransmission of the corresponding PDU by transmitting a status PDU to a transmitting side and restarts the reordering timer. Subsequently, when an SN of a PDU that has been received and is being processed is in sequence and the reordering timer corresponds to the SN, the RLC stops the reordering timer, extracts a service data unit (SDU) on the basis of the SN of the PDU, and delivers the extracted SDU to an upper layer. On the other hand, when the received PDU is not in sequence, the RLC starts the reordering timer and waits until a PDU having the corresponding SN is received.

When the PDU gap disappears as described above, the RLC performs the in-sequence delivery function of delivering data to the upper layer in order of SNs of respective PDUs.

The in-sequence delivery of data reduces the load of reordering in the upper layer. However, since the data cannot be delivered to the upper layer until the PDU gap is filled, a delay occurs in data delivery. For this reason, delivery of application layer data is delayed, and round trip time (RTT) spikes. In particular, the throughput of a transmission control protocol (TCP) application is inversely proportional to RTT. Thus, when the RTT spikes as mentioned above, the TCP throughput drastically deteriorates inversely proportional to the RTT.

### SUMMARY

Accordingly, example embodiments of the present invention are provided to obviate substantially one or more problems due to limitations and disadvantages of the related art.

Example embodiments of the present invention provide a data delivery method of Layer 2 in a mobile communication system capable of reducing a delay of data delivery in the mobile communication system and thereby improving the performance of a transmission control protocol (TCP) application.

In some example embodiments, a data delivery method of Layer 2 in a mobile communication system includes: receiving a protocol data unit (PDU); extracting a service data unit (SDU) from the received PDU regardless of whether or not a PDU gap has occurred; and delivering the extracted SDU to an upper layer of radio link control (RLC).

Here, the data delivery method may further include, while extracting the SDU from the received PDU and delivering the extracted SDU to the upper layer of RLC: determining whether a PDU gap has occurred on the basis of a sequence number (SN) of the received PDU; determining whether a PDU received after a PDU gap has occurred corresponds to the PDU gap that has occurred; and when the PDU received after the PDU gap has occurred corresponds to the PDU gap that has occurred, extracting an SDU from the received PDU corresponding to the PDU gap and delivering the extracted SDU to the upper layer of RLC.

In other example embodiments, a data delivery method of Layer 2 in a mobile communication system includes: determining whether a PDU gap, in which PDUs are not sequentially received, has occurred on the basis of SNs of received PDUs; starting a reordering timer (t_Reordering) when the PDU gap has occurred; when the reordering timer expires and no PDU corresponding to the PDU gap is received, extracting an SDU from at least one PDU which has been received already; and delivering the extracted at least one SDU to an upper layer of RLC.

Here, the data delivery method may further include, when at least one PDU is received after delivering the extracted at least one SDU to the upper layer of RLC: determining whether the received at least one PDU corresponds to the PDU gap; and when the received at least one PDU corresponds to the PDU gap, extracting an SDU from the PDU corresponding to the PDU gap and delivering the extracted SDU to the upper layer of RLC.

In other example embodiments, a data delivery method of Layer 2 in a mobile communication system includes: determining whether a PDU gap, in which PDUs are not sequentially received, has occurred on the basis of an SN of at least one received PDU; when the PDU gap has occurred, starting a specific timer (t_X) having a time set in advance; when no PDU corresponding to the PDU gap is received, extracting an SDU from at least one PDU which has been received already; when the specific timer expires and no PDU corresponding to the PDU gap is received, extracting the SDU from the at least one PDU which has been received already; and delivering the extracted at least one SDU to an upper layer of RLC.

Here, the time of the specific timer may be set to be shorter than that of a reordering timer (t_Reordering) defined in Third Generation Partnership Project (3GPP) technical specification (TS) 36.331.

The data delivery method may further include, when at least one PDU is received after delivering the extracted at least one SDU to the upper layer of RLC: determining whether the received at least one PDU corresponds to the PDU gap; and when the received at least one PDU corresponds to the PDU gap, extracting an SDU from the PDU corresponding to the PDU gap and delivering the extracted SDU to the upper layer of RLC.

In other example embodiments, a data delivery method of Layer 2 in a mobile communication system includes: even when a PDU gap is in at least one PDU received before a handover occurs, extracting, at a receiving apparatus, an SDU from the received at least one PDU and delivering the extracted SDU to an upper layer of a packet data convergence protocol (PDCP); performing, at the receiving apparatus, a handover; and extracting, at the receiving apparatus, an SDU from at least one PDU corresponding to the PDU gap and received after the handover is performed, and delivering the extracted SDU to the upper layer of the PDCP.

In other example embodiments, a data delivery method of Layer 2 in a mobile communication system includes determining a scheme of performing data delivery between in-sequence delivery and out-of-sequence delivery on the basis of a control message received from a base station.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating a data delivery method of Layer 2 according to an example embodiment of the present invention;

FIG. 2 is a conceptual diagram illustrating a data delivery method of Layer 2 according to an example embodiment of the present invention;

FIG. 3 is a flowchart illustrating a data delivery method of Layer 2 according to another example embodiment of the present invention; and

FIG. 4 is a flowchart illustrating a data delivery method of Layer 2 according to still another example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described in detail with reference to the appended drawings. To aid in understanding the present invention, like numbers refer to like elements throughout the description of the figures, and the description of the same component will not be reiterated.

Data delivery methods of Layer 2 in a mobile communication system according to example embodiments of the present invention can be applied to Layer 2 protocols of terminals and/or base stations in various mobile communication systems including Long Term Evolution (LTE), LTE-Advanced, Worldwide Interoperability for Microwave Access (WiMAX), and Wireless Broadband (WiBro) systems. The term “terminal” used herein may be referred to as a mobile station (MS), mobile terminal (MT), user equipment (UE), user terminal (UT), wireless terminal, access terminal (AT), subscriber unit, subscriber station (SS), wireless device, wireless communication device, wireless transmit/receive unit (WTRU), mobile node, mobile, or other terms. Also, the term “base station” used herein generally denotes a fixed point communicating with a device, and may be referred to by other terms such as a Node-B, evolved Node-B (eNode-B), base transceiver system (BTS), access point, transmission point, remote radio head (RRH).

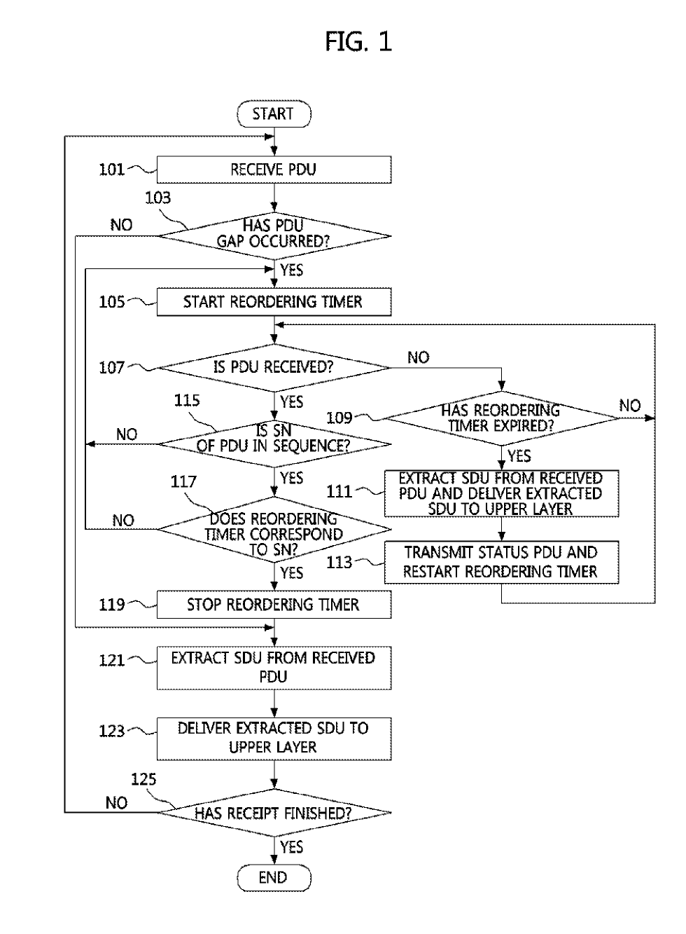

FIG. 1 is a flowchart illustrating a data delivery method of Layer 2 according to an example embodiment of the present invention, in which an out-of-sequence delivery scheme of data performed in a receiving apparatus (terminal or base station) that receives data is illustrated. The data delivery method of Layer 2 illustrated in FIG. 1 can be performed in the radio link control (RLC) layer of the receiving apparatus and applied to an acknowledged mode (AM) transmission mode.

The data delivery method of Layer 2 according to an example embodiment of the present invention will be described with reference to FIG. 1. First, the receiving apparatus receives and stores protocol data units (PDUs) in a receiving buffer (step 101). At this time, the receiving apparatus transmits an acknowledgement message for normally received PDUs to a transmitting apparatus. Also, the receiving apparatus may manage receipt of PDUs using a receiving window having a size set in advance.

The receiving apparatus determines whether a PDU gap has occurred on the basis of sequence numbers (SNs) included in the headers of the PDUs stored in the receiving buffer (step 103). Here, the PDU gap indicates a case in which at least one PDU is not received in sequence while PDUs are received in order of their SNs. For example, when a PDU having an SN of n+5 is received before PDUs having SNs of n+3 and n+4 after PDUs having SNs of n, n+1 and n+2 are received in order of the SNs, it is possible to determined that a PDU gap has occurred between the n+2 PDU and the n+5 PDU.

When it is determined that a PDU gap has occurred, the receiving apparatus starts a reordering timer t_Reordering (step 105). Here, a time (or expiration time) of the reordering timer t_Reordering may be set as defined in Third Generation Partnership Project (3GPP) technical specification (TS) 36.331, for example, the maximum number of hybrid automatic repeat request (HARQ) transmissions×HARQ round trip time (RTT) (=8 ms).

Subsequently, the receiving apparatus determines whether a PDU is received (step 107). When it is determined that no PDU is received, the receiving apparatus determines whether the reordering timer t_Reordering has expired (step 109).

When the reordering timer t_Reordering has expired, the receiving apparatus extracts service data units (SDUs) from the PDUs that have been received up to the time, and delivers the extracted SDUs to an upper layer (i.e., an upper layer of RLC) (step 111). At this time, the receiving apparatus may extract SDUs from only PDUs having SNs before a second PDU gap and deliver the extracted SDUs to the upper layer. After PDUs having SNs included in the first PDU gap are thereafter received normally, the receiving apparatus extracts and delivers SDUs to the upper layer.

Also, the receiving apparatus transmits a status PDU, which requests retransmission of a PDU that has not been received, to the transmitting apparatus, restarts the reordering timer t_Reordering (step 113), and proceeds to step 107. At this time, the status PDU may be transmitted to a peer RLC entity of the transmitting apparatus, and have a higher priority than data PDUs to prevent an unnecessary delay of a status report and a bad influence on a retransmission delay.

When it is determined in step 107 that a PDU is received, the receiving apparatus determines whether an SN of the received PDU is in sequence (step 115). When the SN of the received PDU is in sequence, the receiving apparatus determines whether the currently operating reordering timer t_Reordering corresponds to the SN (i.e., an SN of a PDU included in the PDU gap) (step 117).

When it is determined in step 117 that the currently operating reordering timer t_Reordering corresponds to the SN, the receiving apparatus stops the currently operating reordering timer t_Reordering, extracts SDUs from the received PDUs (step 121), and delivers the extracted SDUs to the upper layer (step 123).

Subsequently, the receiving apparatus determines whether receipt of data has finished (step 125), and repeats the above-described process when receipt of data has not finished.

As illustrated in FIG. 1, in the data delivery method of Layer 2 according to an example embodiment of the present invention, when a PDU gap occurs, the out-of-sequence delivery scheme of extracting SDUs from received PDUs upon expiration of a reordering timer, delivering the extracted SDUs to the upper layer, and transmitting a status PDU to a transmitting apparatus is used. In this way, data delivery is not delayed during a retransmission time, such that RTT of the application layer can be reduced.

In the data delivery method of Layer 2 illustrated in FIG. 1, the out-of-sequence delivery scheme is performed by RLC present on Layer 2 of a receiving apparatus by way of example. However, the present invention is not limited to this case and can be applied to any system that performs data retransmission in Layer 2.

For example, the out-of-sequence delivery scheme of data may be performed by a packet data convergence protocol (PDCP) layer when a handover is performed. In other words, even when there is a PDU gap in PDUs having been received before a handover, a PDCP may extract SDUs from the received PDUs and deliver the extracted SDUs to the upper layer. When at least one PDU corresponding to the PDU gap is received after the handover, the PDCP may extract an SDU from the at least one PDU corresponding to the PDU gap and deliver the extracted SDU to the upper layer.

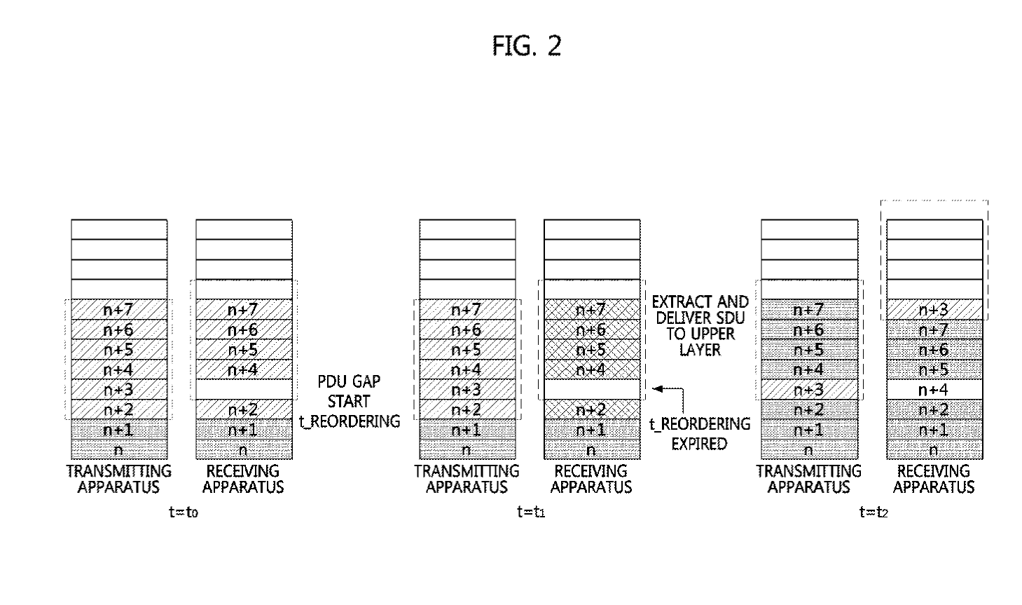

FIG. 2 is a conceptual diagram illustrating a data delivery method of Layer 2 according to an example embodiment of the present invention, that is, the out-of-sequence delivery scheme of data performed by RLC on Layer 2 of a receiving apparatus in an environment in which a transmitting apparatus and the receiving apparatus operate in the AM transmission mode as illustrated in FIG. 1.

Referring to FIG. 2, when a transmitting apparatus and a receiving apparatus each operate in the AM transmission mode, an RLC entity on Layer 2 of each of the transmitting apparatus and the receiving apparatus has both a transmitting function and a receiving function. However, for convenience, FIG. 2 illustrates by way of example that the RLC entity of the transmitting apparatus transmits PDUs on the basis of a transmitting window, and the RLC entity of the receiving apparatus performs out-of-sequence delivery for the PDUs received on the basis of a receiving window.

First, at a time t₀, PDUs having SNs of n+2 to n+7 are transmitted from a transmitting buffer of the transmitting apparatus. PDUs having SNs of n and n+1 have been transmitted before the time t₀, and acknowledgements have been received from the receiving apparatus. Thus, the transmitting window of the transmitting apparatus is located behind the n+2 PDU that has not yet been acknowledged by the receiving apparatus.

Meanwhile, at the time t₀, the receiving apparatus receives the PDU having the SN of n+2 transmitted from the transmitting apparatus, and receives the n+4 to n+7 PDUs without receiving an n+3 PDU after the receiving window moves to the position of the n+3 PDU expected to be received thereafter. In other words, the n+3 PDU has not been received, and a PDU gap has occurred. When the PDU gap occurs as described above, waiting endlessly for the PDU that has not been received may make a queue stagnant, and thus the receiving apparatus starts the reordering timer t_Reordering for the PDU that has not been received.

Subsequently, at a time t₁, the reordering timer expires, and the PDU having the SN of n+3 has not been received. At this time, the receiving apparatus extracts SDUs from the PDUs having the SNs of n+2 and n+4 to n+7, delivers the extracted SDUs to the upper layer, and transmits a status PDU, which requests retransmission of the n+3 PDU, to the transmitting apparatus.

At a time t₂, the transmitting apparatus receiving the status PDU checks that the PDUs having the SNs of n+2 and n+4 to n+7 have been correctly received, and retransmits the PDU having the SN of n+3.

When an acknowledgement message for the retransmitted PDU having the SN of n+3 is received thereafter, the transmitting apparatus may move the transmitting window behind the acknowledged n+4 to n+7 PDUs in the transmitting buffer, and transmit PDUs included in the moved transmitting window.

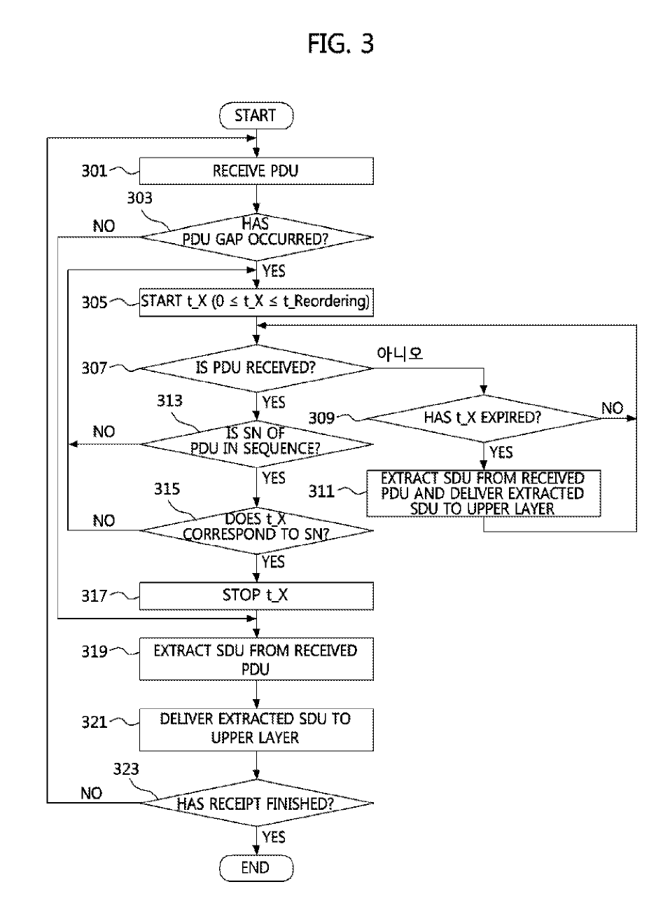

FIG. 3 is a flowchart illustrating a data delivery method of Layer 2 according to another example embodiment of the present invention, in which an out-of-sequence delivery scheme of, when a PDU gap occurs, extracting SDUs from PDUs that have already been received and delivering the extracted SDUs to an upper layer before the reordering timer t_Reordering mentioned in FIG. 1 expires is illustrated as an example.

Referring to FIG. 3, first, a receiving apparatus receives and stores PDUs in a receiving buffer (step 301). At this time, the receiving apparatus may transmit acknowledgement messages for normally received PDUs to a transmitting apparatus, and manage receipt of PDUs using a receiving window having a size set in advance.

The receiving apparatus determines whether a PDU gap has occurred on the basis of SNs included in the headers of the PDUs stored in the receiving buffer (step 303). When it is determined that a PDU gap has occurred, the receiving apparatus starts a specific timer t_X having a time set in advance (step 305). Here, the time of the specific timer t_X may be shorter than that of the reordering timer t_Reordering applied to the example embodiment of the present invention illustrated in FIGS. 1 and 2. For example, the time of the specific timer t_X may be set to half of that of the reordering timer t_Reordering, or shorter or longer than half of that within a time range of the reordering timer t_Reordering.

Subsequently, the receiving apparatus determines whether a PDU is received (step 307). When it is determined that no PDU is received, the receiving apparatus determines whether the specific timer t_X has expired (step 309). When the specific timer t_X has expired, the receiving apparatus extracts SDUs from the PDUs that have been received up to the time, and delivers the extracted SDUs to an upper layer (step 311). At this time, the receiving apparatus may extract SDUs from only PDUs having SNs before a second PDU gap and deliver the extracted SDUs to the upper layer. PDUs having SNs included in the first PDU gap are thereafter received normally, and then the receiving apparatus extracts and delivers SDUs to the upper layer.

When it is determined in step 307 that a PDU is received, the receiving apparatus determines whether an SN of the received PDU is in sequence (step 313). When the SN of the received PDU is in sequence, the receiving apparatus determines whether the currently operating specific timer t_X corresponds to the SN (i.e., an SN of a PDU included in the PDU gap) (step 315).

When it is determined in step 315 that the currently operating specific timer t_X corresponds to the SN, the receiving apparatus stops the currently operating specific timer t_X, extracts SDUs from the received PDUs (step 319), and delivers the extracted SDUs to the upper layer (step 321).

Subsequently, the receiving apparatus determines whether receipt of data has finished (step 323), and repeats the above-described process when receipt of data has not finished.

As illustrated in FIG. 3, in the data delivery method of Layer 2 according to another example embodiment of the present invention, when a PDU gap occurs, the out-of-sequence delivery scheme of extracting SDUs from received PDUs if the specific timer t_X set in advance expires before the reordering timer t_Reordering expires, delivering the extracted SDUs to the upper layer, and transmitting a status PDU to a transmitting apparatus is used, such that an RTT spike can be completely prevented.

Also, as illustrated in FIG. 3, when out-of-sequence delivery is performed on the basis of a time set in advance (i.e., t_X expiration time), the load of reordering may increase in the upper layer. However, during reordering of data, a fast retransmit algorithm using three-duplicate ACKs is complemented by applying transmission control protocol (TCP)-detection of out-of-order and response (DOOR), reordering robust (RR)-TCP, etc., like in a high-speed wired network, such that performance deterioration can be prevented.

The data delivery method of Layer 2 illustrated in FIG. 3 according to another example embodiment of the present invention can be applied to the AM or an unacknowledged mode (UM) transmission mode.

Also, whether radio bearers of a terminal and a base station perform a conventional in-sequence delivery scheme or an out-of-sequence delivery scheme according to an example embodiment of the present invention may be determined according to the setting of radio resource control (RRC).

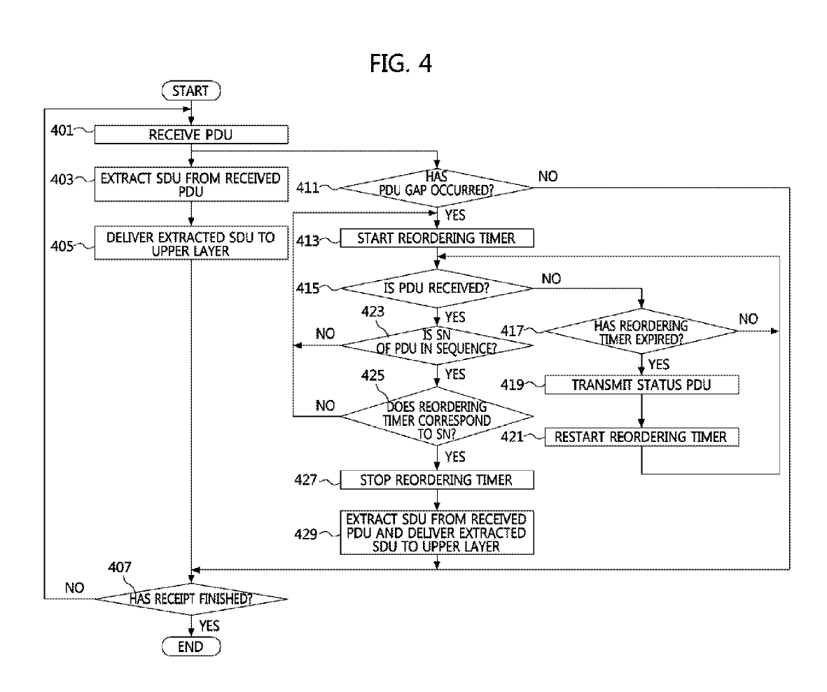

FIG. 4 is a flowchart illustrating a data delivery method of Layer 2 according to still another example embodiment of the present invention, in which an out-of-sequence delivery scheme of extracting SDUs from received PDUs and delivering the extracted SDUs to an upper layer regardless of whether or not a PDU gap occurs is illustrated as an example.

Referring to FIG. 4, first, a receiving apparatus receives PDUs (step 401). Then, the receiving apparatus extracts SDUs from the received PDUs (step 403), and delivers the extracted SDUs to an upper layer (step 405). At this time, the receiving apparatus extracts the SDUs from the received PDUs regardless of whether or not a PDU gap occurs, and delivers the extracted SDUs to the upper layer in real time.

Subsequently, the receiving apparatus proceeds back to step 401 to perform the following process, thereby repeating the process of receiving a PDU, extracting an SDU from the received PDU, and delivering the extracted SDU to the upper layer.

While performing the process of extracting the SDUs from the received PDUs and delivering the extracted SDUs to the upper layer, the receiving apparatus also determines whether or not a PDU gap has occurred on the basis of SNs included in the headers of the received PDUs (step 411). When a PDU gap has occurred, the receiving apparatus starts a reordering timer (step 413). Here, a time of the reordering timer may be set as defined in 3GPP TS 36.331.

The receiving apparatus determines whether a PDU is received after the reordering timer has been started (step 415). When it is determined that no PDU is received, the receiving apparatus determines whether the reordering timer has expired (step 417).

When the reordering timer has expired, the receiving apparatus transmits a status PDU, which requests retransmission of a PDU that is included in the PDU gap and has not been received, to a transmitting apparatus (step 419), restarts the reordering timer (step 421), and proceeds to step 415.

On the other hand, when it is determined in step 415 that a PDU is received, the receiving apparatus determines whether an SN of the received PDU is in sequence (step 423). When the SN of the received PDU is in sequence, the receiving apparatus determines whether the currently operating reordering timer corresponds to the SN (i.e., an SN of a PDU included in the PDU gap) (step 425).

When it is determined in step 425 that the currently operating reordering timer corresponds to the SN, the receiving apparatus stops the currently operating reordering timer (step 427), and extracts an SDU from the received PDU and delivers the extracted SDU to the upper layer (step 429).

As illustrated in FIG. 4, in the data delivery method of Layer 2 according to still another example embodiment of the present invention, the out-of-sequence delivery scheme of extracting SDUs from received PDUs and delivering the extracted SDUs to the upper layer regardless of a specific time and whether or not a PDU gap occurs is performed, and reordering of the SDUs received from Layer 2 is performed in the upper layer.

The out-of-sequence delivery schemes according to example embodiments of the present invention as described above can be selectively performed in the radio link layer of a receiving apparatus (e.g., a UE) according to a control message of a base station. In other words, the radio link layer of a UE can set whether to perform in-sequence delivery or out-of-sequence delivery according to a control message transmitted from a base station.

When a data delivery method of Layer 2 in a mobile communication system as described above is used in a process of delivering data from Layer 2 of terminals and base stations to an upper layer in mobile communication systems including LTE, LTE-Advanced and WiMAX systems, a PDU is received, and an SDU is extracted from the received PDU and delivered to the upper layer in real time. Alternatively, when a PDU gap occurs and a reordering timer or a specific timer having a shorter time than the reordering timer expires, an out-of-sequence delivery of extracting SDUs from PDUs that have been already received, delivering the extracted SDUs to the upper layer, and delivering a status PDU, which requests retransmission of a PDU that has not been received normally, to a transmitting apparatus is performed.

Thus, when a HARQ failure or HARQ feedback NACK-to-ACK error occurs, or a handover is performed, a delay of data delivery can be reduced while RLC retransmits an ARQ or the PDCP retransmits a PDU. Also, such a reduction in delay of data delivery can reduce RTT of the application layer and ultimately improve the performance of a TCP application.

While the example embodiments of the present invention and their advantages have been described in detail, it should be understood that various changes, substitutions and alterations may be made herein without departing from the scope of the invention.

What is claimed is:

1. A data delivery method performed in a receiving apparatus of a mobile communication system, comprising:
receiving a protocol data unit (PDU);
extracting a service data unit (SDU) from the received PDU regardless of whether or not a PDU gap occurs; and
delivering the extracted SDU to an upper layer of radio link control (RLC).

2. The data delivery method of claim 1, further comprising, while extracting the SDU from the received PDU and delivering the extracted SDU to the upper layer of RLC:
determining whether a PDU gap has occurred on the basis of a sequence number (SN) of the received PDU;
determining whether a PDU received after a PDU gap has occurred corresponds to the PDU gap that has occurred; and
when the PDU received after the PDU gap has occurred corresponds to the PDU gap that has occurred, extracting an SDU from the received PDU corresponding to the PDU gap and delivering the extracted SDU to the upper layer of RLC.

3. A data delivery method performed in a receiving apparatus of a mobile communication system, comprising:
determining whether a protocol data unit (PDU) gap, in which PDUs are not sequentially received, has occurred on the basis of sequence numbers (SNs) of received PDUs;
starting a reordering timer when the PDU gap has occurred;
when the reordering timer expires and no PDU corresponding to the PDU gap is received, extracting a service data unit (SDU) from at least one PDU which has been received already; and
delivering the extracted at least one SDU to an upper layer of radio link control (RLC).

4. The data delivery method of claim 3, further comprising, when at least one PDU is received after delivering the extracted at least one SDU to the upper layer of RLC:
determining whether the received at least one PDU corresponds to the PDU gap; and
when the received at least one PDU corresponds to the PDU gap, extracting an SDU from the PDU corresponding to the PDU gap and delivering the extracted SDU to the upper layer of RLC.

5. A data delivery method performed in a receiving apparatus of a mobile communication system, comprising:
determining whether a protocol data unit (PDU) gap, in which PDUs are not sequentially received, has occurred on the basis of a sequence number (SN) of at least one received PDU;
when the PDU gap has occurred, starting a specific timer having a time set in advance;
when no PDU corresponding to the PDU gap is received, extracting a service data unit (SDU) from at least one PDU which has been received already;
when the specific timer expires and no PDU corresponding to the PDU gap is received, extracting the SDU from the at least one PDU which has been received already; and
delivering the extracted at least one SDU to an upper layer of radio link control (RLC).

6. The data delivery method of claim 5, wherein the time of the specific timer is shorter than that of a reordering timer defined in Third Generation Partnership Project (3GPP) technical specification (TS) 36.331.

7. The data delivery method of claim 5, further comprising, when at least one PDU is received after delivering the extracted at least one SDU to the upper layer of RLC:
determining whether the received at least one PDU corresponds to the PDU gap; and
when the received at least one PDU corresponds to the PDU gap, extracting an SDU from the PDU corresponding to the PDU gap and delivering the extracted SDU to the upper layer of RLC.

8. A data delivery method performed in a receiving apparatus of a mobile communication system, comprising:
even when a protocol data unit (PDU) gap is in at least one PDU received before a handover occurs, extracting, at the receiving apparatus, a service data unit (SDU) from the received at least one PDU and delivering the extracted SDU to an upper layer of a packet data convergence protocol (PDCP);
performing, at the receiving apparatus, a handover; and
extracting, at the receiving apparatus, an SDU from at least one PDU corresponding to the PDU gap and received after the handover is performed, and delivering the extracted SDU to the upper layer of the PDCP.

9. A data delivery method performed in Layer 2 of a receiving apparatus, comprising:
receiving a control message from a base station; and
determining a scheme of performing data delivery between in-sequence delivery and out-of-sequence delivery on the basis of the received control message.
